(19) United States
(12) Patent Application Publication
(10) Pub. No.: US 2025/0165883 A1
(43) Pub. Date: May 22, 2025

(54) Method for dynamic model-based project benchmarking, planning, and forecasting

(71) Applicant: Gloria J. Miller, Wiesloch (DE)

(72) Inventor: Gloria J. Miller, Wiesloch (DE)

(21) Appl. No.: 19/032,574

(22) Filed: Jan. 21, 2025

Related U.S. Application Data
(62) Division of application No. 16/950,659, filed on Nov. 17, 2020, now abandoned.
(60) Provisional application No. 62/927,219, filed on Oct. 29, 2019.

(51) Int. Cl. G06Q 10/0631; G06F 9/54; G06F 17/18; G06F 18/24; G06Q 10/0639

(52) U.S. Cl. CPC G06Q 10/063114; G06F 9/547; G06F 17/18; G06F 18/24; G06Q 10/06393

(57) ABSTRACT

A method for comparing and benchmarking projects utilizing computational models for scoring and classifying projects and utilizing historical or reference data for producing multifaceted, scalable vector graphics reports. The system is dynamic for loading project scoring models that follow a given structural specification, for being configured to report on project histories or reference data, and for reporting on multiple project aspects using customizable graphic reports.

### CROSS-REFERENCE TO RELATED APPLICATIONS

This is a division for application Ser. No. 16/950,659, filed on Nov. 17, 2020, with title “Method for Model-based Project Scoring Classification and Reporting” and naming inventor Gloria Jean Miller, which claims the benefit of priority under 35 U.S.C § 119 (e) to U.S. Provisional Application No. 62/927,219, filed Oct. 29, 2019, entitled “System and Method for Model-based Project Classification and Reporting.” All of the foregoing applications are hereby incorporated herein by reference in their entirety.

### BACKGROUND

Projects are used for introducing changes and transitions into organizations; they are one form of temporary organization that firms use to drive growth. They are successful when they deliver the expected output and achieve their intended objective. The number of potential configurations for a project is so numerous that finding reference projects for planning and forecasting success is difficult. Conventional project management computational models are topic-specific; they are limited to predefined or single subjects such as scheduling, risk management, or defect management. Alternatively, they offer little insights to support dynamic project environments and themes. Benchmarking systems are constrained to analyzing individual project dimensions without providing intelligence by identifying comparable projects using multiple dimensions. Project reports fail to provide aggregated visualization of comparable project dimensions, or they focus on a single project subject. Finally, project management reports are not dynamic in providing comparative and benchmark data in a coherent, multi-dimensional fashion.

### SUMMARY

The disclosed system uses computational models to compute scores, classify projects, and provide reports on project attributes and historical projects for comparison purposes. The comparison results can be used to formulate success criteria that can be measured and monitored during the project. For example, leading indicators could be defined around important aspects of personal quality and system use. The project scoring, classification, and reporting methods and system described herein include a plurality of components shown in the various figures and process flows. It has a benefit over traditional methods as it provides a structure and method for using a multitude of computational models to identify comparable projects and to provide comparison and benchmark reports on multiple aspects of historical projects. It provides managers with context-relevant data for project planning and forecasting project outcomes. Project reports aggregate a multitude of project attributes for comparable project dimensions into visual reports. Such artificial intelligence systems are needed to consolidate past experiences and learnings and make them available for active project management in a coherent, comparable method.

### BRIEF DESCRIPTION OF FIGURES

In the figures, the same reference number in different figures indicates similar or identical items.

FIG. 1 illustrates an overview of the data input of project attributes to produce a consolidated report.

FIG. 2 illustrates an overview of the project scoring and classification engine.

FIG. 3 is a process follow for the details of the project scoring and classification engine.

FIG. 4 is an exemplar diagram of the project attribute data entry.

FIG. 5 illustrates the input of a unique project identifier to produce a consolidated project report.

FIG. 6 is an exemplar consolidated report illustrating the inclusion of multiple report layout items.

FIG. 7 is an exemplar demonstrating a single report layout item.

FIG. 8 is a block diagram depicting an integrated view of the computing environment for project scoring, classification, and reporting described herein.

### DETAILED DESCRIPTION

This disclosure describes systems, methods, and computer-readable media for scoring project attributes, classifying projects given a computational model, and creating multi-dimensional, vector graphic reports of project attributes based upon classification models. The disclosed system uses data items as input to computational models to identify and report on comparable projects. The models are necessary to support data-driven methods, digital workflows, and analytics for performance management, planning, and forecasting. The disclosed use of artificial intelligence is suitable for navigating the numerous potential project configurations to facilitate project success.

Project attributes represent characteristics or traits of a project that describe its scope, technical, human, or financial resource usages or project objectives. Measurement items are variables that include mathematical or statistical attributes or values. The measurement items are the contingency factors from past projects that define the infrastructure, personnel, technical tasks, and governance for a project. These measurement items can facilitate discussions to assign accountable human and financial resources to the project goals. Furthermore, the measurement items can be used as a template for risk identification as the success factors are the inverse of risk factors. The computation models created through machine learning methods include models such as factor analysis model, cluster analysis model, multiple regression analysis model, or other methods based upon the execution of past projects. The models take the measurement items as input and produce scores and classifications that can be used to group and to compare projects.

The following is an overview of the system features. There is a project attribute process for user data entry or application programming interface input of attributes associated with a project, storing the attributes in computer memory 724, and passing them to other processes for further usage. A project scoring and classification engine for receiving project attributes that map to one or more computation models for scoring, generating a unique identification, classifying the project, and saving the results to a database record. There are a project scoring and classification engine to initiate the execution of a consolidated report 340. A project reporting engine to create a consolidated report 340 for a reference project given by a unique project identification; the engine combines reports composed of one or more report layout programs. The report layout programs call a report comparison queries program to deliver data content from a history datastore. Each report layout program populates a graphic report design with the requested data. The results from the individual report layout programs are rendered into a consolidated report 340. The report comparison queries deliver data about the reference project and comparative computational data about projects from the history datastore with the same classification as the reference project.

The content of the report layout programs can be adjusted to include text, numbers, tables, graphs, charts, and other visualizations to compare the reference project with other projects. The report layout programs can be extended to a plurality of report styles. The project comparison queries can be adjusted to compare any useful historical project data or data from representative models that are available in the history datastore. The concepts in this disclosure are useful for comparing project critical success factors, success criteria, or other relevant content.

The proposed method offers the following advantages. It provides a dynamic, flexible project management comparison and the benchmarking method by using any number and type of computational models. It is not constrained to analyzing a single project management subject or attribute. It offers a multi-dimensional analysis of data so that more than one aspect of a project may be analyzed and compared at once. It provides a multitude of cohesive, visual project comparison, or benchmark charts using scalable vector graphics. Further benefits are apparent in the details described with reference to the accompanying figures.

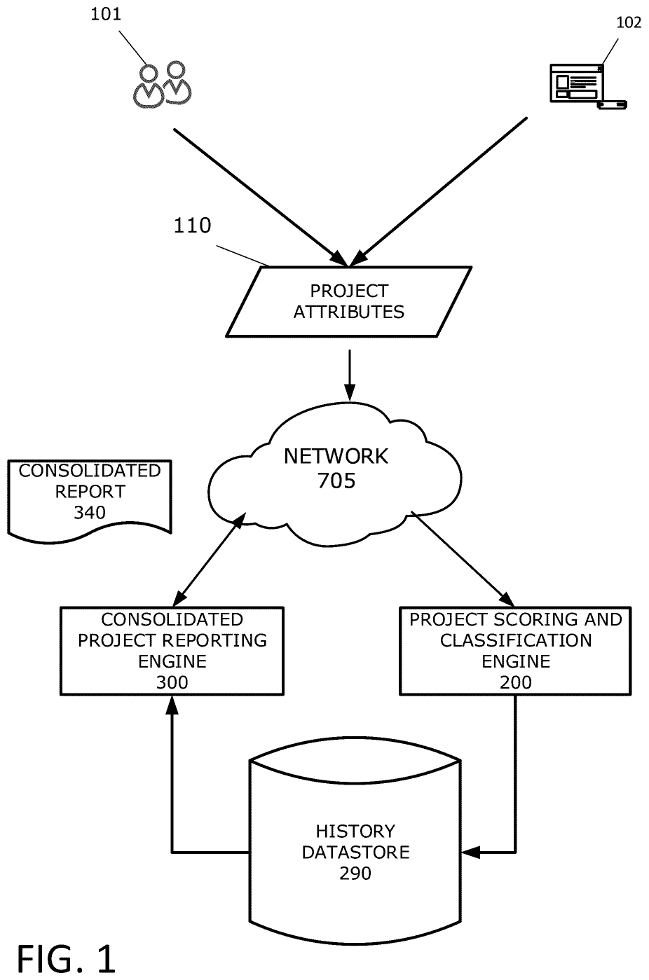

FIG. 1 is a block diagram that illustrates a project attributes 110 as input into the project scoring and classification engine 200 over a network 705. The project attributes 110 may be provided by be provided from a plurality of sources such as an end-user 101 inputting data through user interface 729, such as a keyboard (not shown on the diagram), or by an application programming interface 102 through a webservice (not shown on the diagram). The project scoring and classification engine 200 scores the attributes, classifies the project and saves the results to the history datastore 290. The project scoring and classification engine 200 calls the consolidated project reporting engine 300, which produces consolidated report 340 and presents it to the end-user 101 over the network 705. Consolidated report 340 compares the project attributes with historical or reference data that has the same project classification as those represented by the project attributes 110. Historical data are project attributes and details from past projects. Reference data are project attributes and details that are statistical representations of project data, for example, average values, sums, standard deviations computed based upon a statistical or computational model.

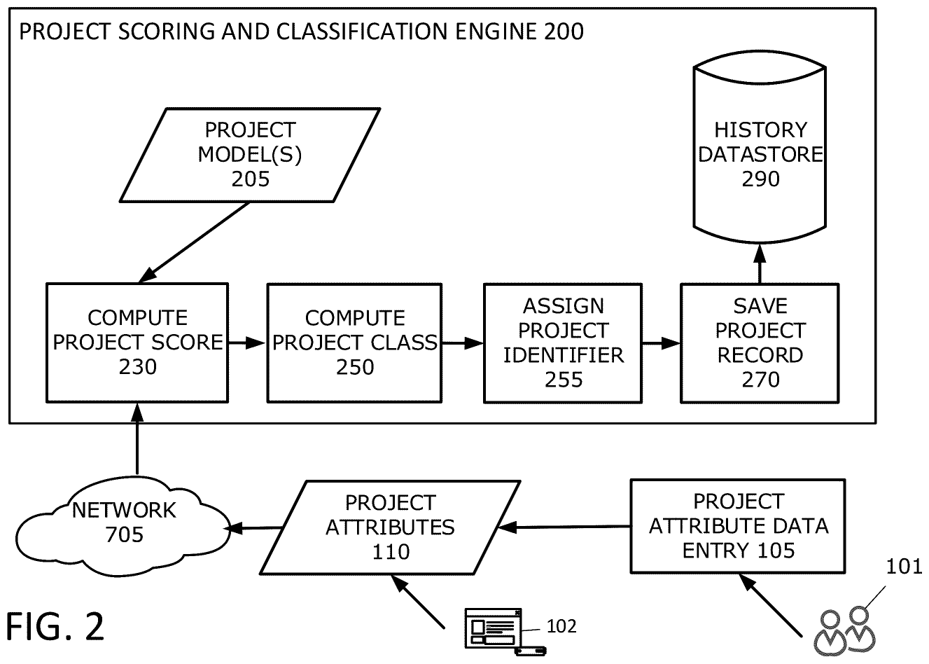

In FIG. 2, compute project score 230 takes the project attributes 110 as input over the network 705, uses project models 205 to compute a project score 220. Compute project class 250 determines the project class 240 using project score 220. Assign project identifier 255 assigns a unique project identifier 260 and save project record 270 writes the results to history datastore 290, including the project score 220, project class 240, project attributes 110, and unique project identifier 260.

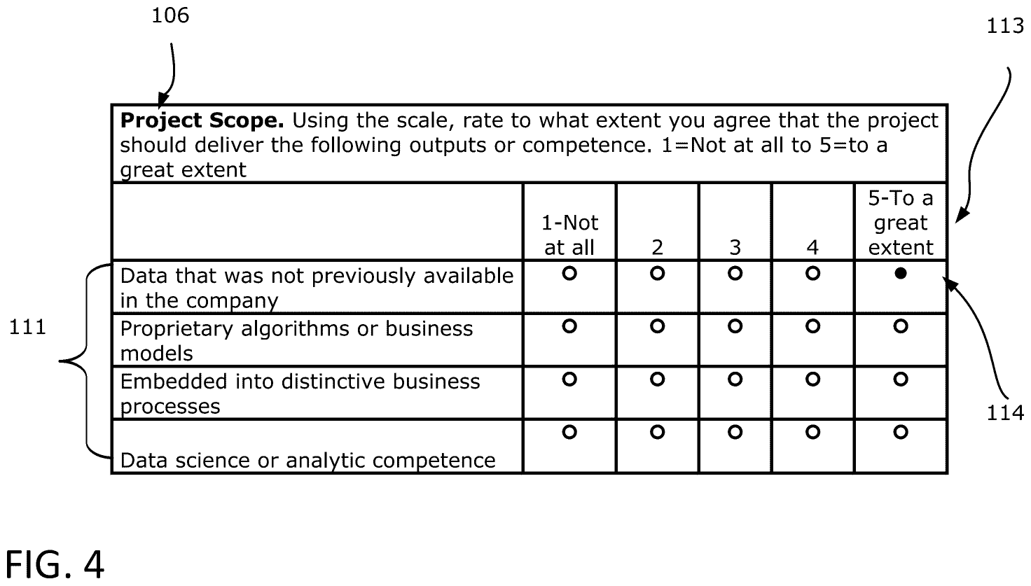

In further detail, FIG. 2 is a block diagram that illustrates a project attribute data entry 105 as an interface into project attributes 110. The project attribute data entry 105 is used by an end-user to input data through user interface 729, such as a keyboard (not shown on the diagram). The project attribute data entry 105 is a computer software program that accepts as input a multitude of project attributes 110. Each project attribute has a project attribute identifier 112 and a project attribute value 114, and it may have a project attribute label 111 and a project attribute score 113. The project attribute label 111 is a descriptive title; the project attribute identifier 112 is a unique reference to the variable. The project attribute score 113 is a range of valid values for project attribute value 114; it is relevant for some types of project attributes 110. The project attribute value 114 is the content or selected value for the project attribute 110. Unique project identifier 260 for an existing project record may be provided as a project attribute 110. The project attributes 110, where the project attribute identifier 112 matches a model dimension identifier 213, is used for scoring and classifying projects in the project scoring and classification engine 200. Further project attributes may be passed to compute project score 230 for storage in the history datastore 290. The project attribute data entry 105 collects the input for the project attribute 110, stores the input in the computer memory 724, and passes the input to compute project score 230 for further processing. Example content for project attribute data entry 105 is provided in FIG. 4. FIG. 2 block diagram illustrates how an application programming interface 102 may be used to input the project attributes 110 through a webservice or other system interface.

The compute project score 230 in FIG. 2 receives as input over the network 705 the project attributes 110 from computer memory 724 or as parameters from an application programming interface 102. It reads project models 205 from a computer-readable media into the computer memory 724. Compute project score 230 can be processed for more than one project at a time as an interactive or a batch process. For each model dimension 210 provided as project attributes 110, it applies the model scoring rules 218 to produce the model class score 219. The compute project class 250 uses the model classification rules 241 to assign project class 240, the model class identifier 243, and the model class label 245. Assign project identifier 255 assigns a unique project identifier 260 if one is not provided with the project attributes 110. The unique project identifier 260 remains available in the computer memory 724 until such time as the session is closed or terminated. The project scoring and classification engine 200 is composed of a multitude of software programs written in a computer programming language such as JavaScript and database objects stored in relational databases.

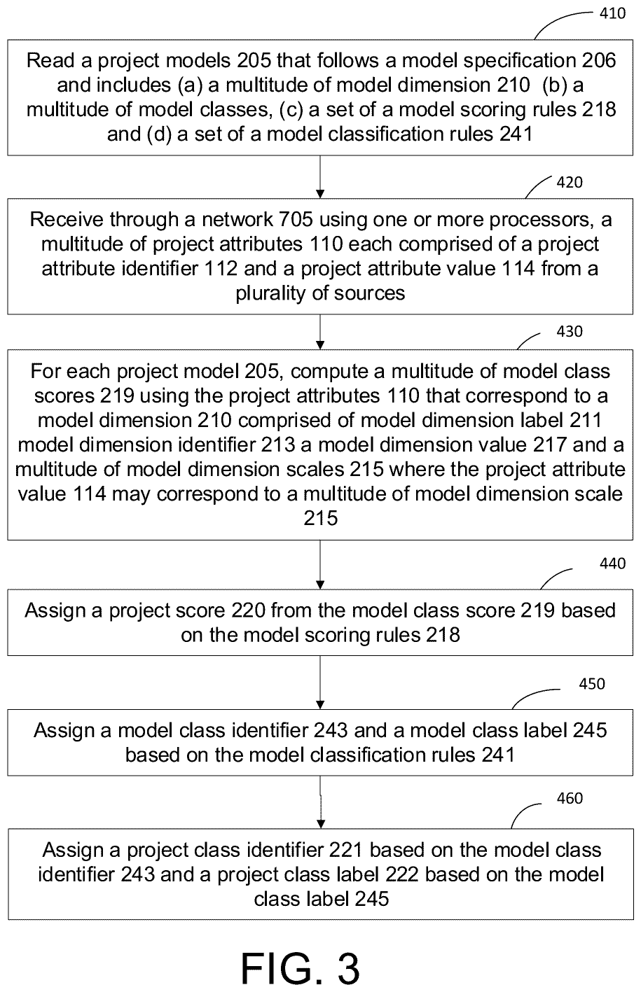

FIG. 3 is a process flow that describes the components from compute project score 230 and compute project class 250 that use the project models 205 to transform the project attributes 110 into the project classification and score. Process steps 410, 420, 430, 440 take places in the compute project score 230 and process steps 450, 460 take places in compute project class 250. Further specifications of the components are describing in the following section.

Project models 205 can be produced with machine learning methods and include models such as a regression analysis model, a factor analysis model, a cluster analysis model, or a topic model. The analytical methods used to produce the project models 205 are produced by a first application that is not included in this disclosure. The components of the project models 205 are: (a) a multitude of model dimension 210, (b) a multitude of model classes, (c) a model scoring rules 218, and (d) a model classification rules 241. Each model dimension 210 includes (a) a model dimension identifier 213, (b) a model dimension label 211, (c) a model dimension scale 215 when necessary, and (d) a model dimension value 217.

The model dimension identifier 213 is a unique reference for a variable in the model. The model dimension label 211 is a descriptive title for the model dimension identifier 213. The model dimension scale 215 is a range of valid values for the model dimension identifier 213; model dimension scale 215 is not relevant for all types of models. The model dimension value 217 is a value used in the scoring process. There may be a model dimension value 217 per model dimension scale 215 when relevant for the type of model. Each of the model classes includes (a) a model class score 219, (b) a model class identifier 243, and (c) a model class label 245.

The model scoring rules 218 are used to produce model class score 219 using the model dimension 210 and the project attributes 110. The model class score 219 is assigned as the project score 220 based on the model scoring rules 218. The model classification rules 241 are used to identify the model class identifier 243 and model class label 245 that corresponds to the project score 220. The model class label 245 is a descriptive identifier for the model class identifier 243. The model class identifier is assigned as or set equivalent to the project class identifier 221, and the model class label 245 is assigned as or set equivalent to the project class label 222. The model scoring rules 218 and the model classification rules 241 can use a multitude of mathematical formulas, statistical computations, logical rules, or logical comparison of words. The form of the rules is decided by the type of project models.

Project models 205 must be stored in a computer-readable format. They are read from the computer-readable media 723 into the computer memory 724 for processing by one or more processing units 721. Different terminology may be used to have the same or similar meaning depending upon the context and type of model. For example, projects have attributes; models have dimensions. Dimensions may be referred to as a measurement item. Based on the type of model, model dimension value 217 may be factor loadings or scores. Formulas may contain variables and intercepts. Project models 205 are produced by software packages such as statistical, data mining, text mining, or other software.

Shown in FIG. 4 is an exemplar layout for project attribute data entry 105. Each of the four descriptive labels as project attribute label 111, map to one or more model dimension 210, and represent a project attribute 110. The project attribute value 114 is determined by the end-user, making a selection through user interface 729. The project attributes score 113 maps to a model dimension value 217 (for example, 5). The descriptive information 106 guides the end-user on how to enter the data. Other descriptive information such as a project name may also be included as a data item in project attribute data entry 105 (not shown in the diagram). The project attribute data entry 105 may capture data for more than one project models 205. The information passed from project attribute data entry 105 or application programming interface 102 to compute project score 230 must use the model dimension identifier 213 for computations to occur. In the FIG. 4 example, for the Project Scope (PS) Model, the selection for “Data that was not previously available in the company” must transfer the data as model dimension identifier 213 as PS_1.

This disclosure describes the model specification 206 for Project Scope Model and Team Structure (TS) Model. When other computational models are used, compute project score 230 must be customized to align to project models 205 to the computational model's model specification 206. The following guides were used for the models in this disclosure. Three variables are produced as part of the computations: the model class score 219, the model class identifier 243, the model class label 245. Correspondingly, three data items are written to the history datastore 290 as project data items: the project score 220, the project class identifier 221, and the project class label 222. The data item naming convention is similar for different types of models-for example, PS_score, PS_class, PS_label. The names can be adjusted to a descriptive name relevant to the model. The names must be consistent across the project models 205, compute project score 230, history datastore 290, report comparison queries 330. Utility processes to load into or to add the model in the project models 205 are necessary. By load, we mean to transfer the electronic data from one computer storage medium located on a computing system to another computer storage medium located on a different computing system. The utility process is not shown in any diagrams.

Project Scope Model is comprised of four dimensions and two classes; each dimension has five scales and individual values per scale. The Team Structure Model is comprised of six dimensions and two classes; five dimensions have five scales, and one dimension has three scales; each scale has values. The cumulated total of the individual values per scale per class sum to one; some scale, class, dimension values may be zero. The model scoring rules 218 and model classification rules 241 are the same for all three models. For the model scoring rules 218, a score is computed per class, and the class with the highest value is assigned as the model class score 219 and the project score 220. For the computation of the score, the project attribute score 113 that corresponds to model dimension scale 215 determines the model dimension value 217. All the model dimension value 217 in a class are summed to a cumulated total for the score. The model classification rules are the model class identifier 243 and model class label 245 that corresponds to the model class score 219 are assigned as the project class identifier 221 and project class label 222. Models similar to those provided in this disclosure can be produced by using machine learning techniques such as Latent Class Analysis.

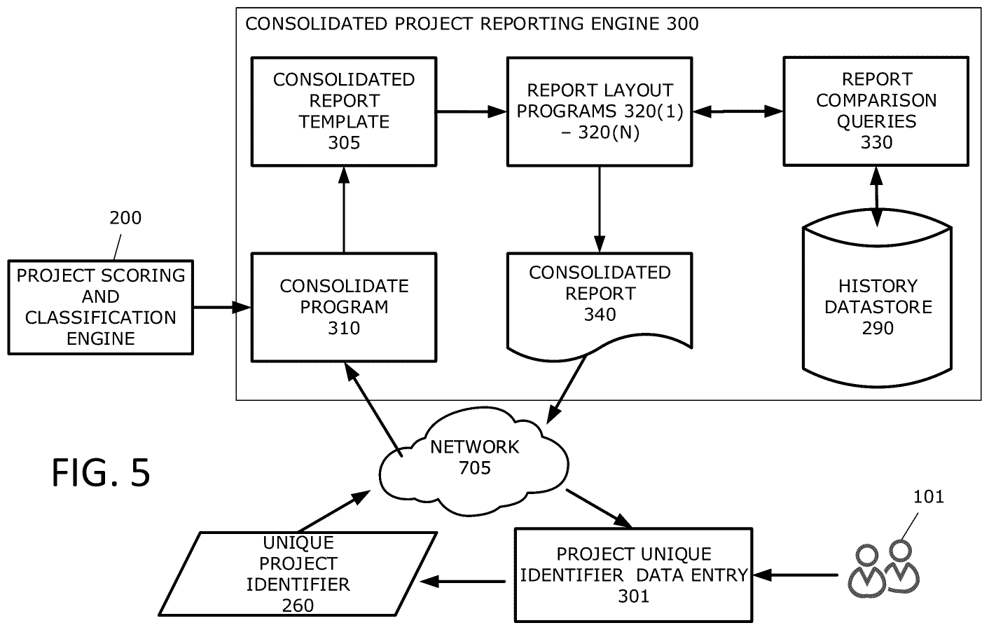

An illustrative example of the model scoring rules 218 for Project Scope Model is as follows. If five were selected for project attributes 110 for 107 for each dimension on FIG. 5, then using the model specification 206, the model dimension value 217 for the model dimensions would be PS_1=0.39, PS_2=0.52, P_3=0.54, P_4=0.34 for the first class, and PS_1=0.08, PS_2=0.0, P_3=0.08, P_4=0.04 for class two. Therefore, model class score 219 would be 1.79 for the first class and 0.20 for the second class. Therefore, the highest value for the model class score 219 would be 1.79, and the project score 220 would be 1.79. Based on the model classification rules 241, the class identifier 243=1 and class label 245 equals “Big Data. Analytics” would be assigned as the project class 240, comprised of the project class identifier 221 and project class label 222, respectively.

The save project record 270 writes the project score 220, project class 240, project attributes 110, and the unique project identifier 260 into a history datastore 290. If a database record exists with the unique project identifier 260, it performs an update; otherwise, it adds a new record. The history datastore 290 may have as many data items as relevant and interesting for project comparison purposes. For example, the store may have data items for project efficiency, team structure, stakeholder contribution, project scope, project demographics, organization demographics, project structure, quality requirements. Data items are equivalent to a database column or database field. Each record must have data items that correspond to the project models 205 being referenced by the project scoring and classification engine 200. The structure of the history datastore 290 must preexist in advance used by the save project record 270.

A label is a descriptive identifier; labels may be stored in the history datastore 290 as a data item, a lookup value, or a format. The decision on how to treat a label will depend on the database technology used for the history datastore 290. Within this disclosure, the multitude of labels (e.g., the project attribute label 111, the model class label 245) are described as separate data items.

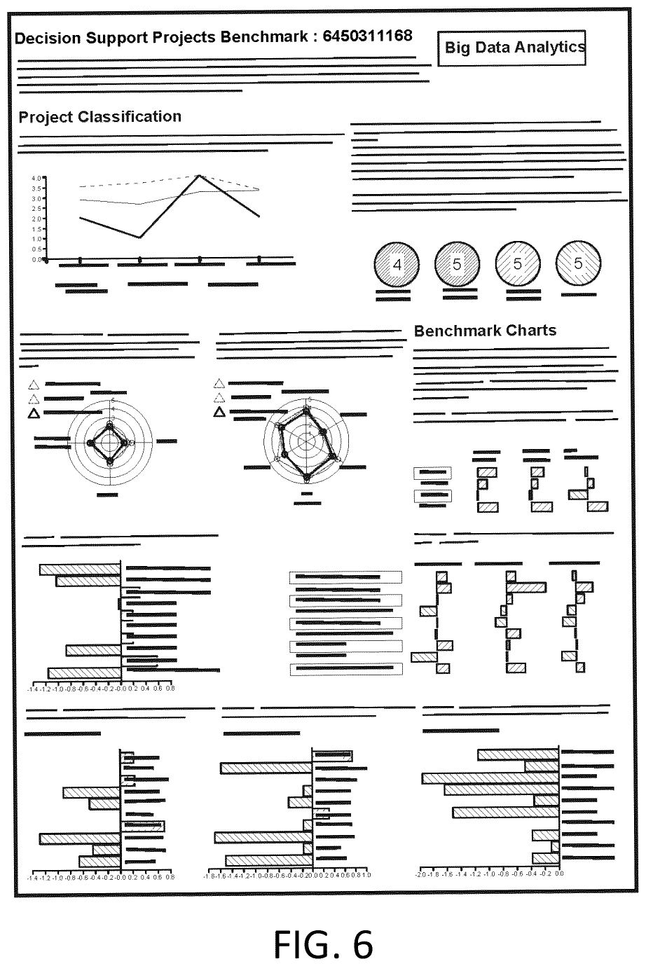

FIG. 5 illustrates the consolidated project reporting engine 300. The consolidated program 310 receives unique project identifier 260 via the network 705 by end-user data entry in project unique identifier data entry 301 or from the computer memory 724 and executes consolidated report template 305. Consolidated report template 305 contains a report layout structure that is a mixture of text and program calls to one or more report layout programs 320(1)-320(N), which reflect the comparisons, look, feel, content, and format for consolidated report 340. In report layout programs 320(1)-320(N), the N is an integer greater than or equal to one. An example layout for consolidated report 340 is given in FIG. 6. Report layout programs 320(1)-320(N) produces diagrams in a scalable vector graphic format that may be animated and are high quality at any resolution. Other image formats are possible. Each report layout programs 320(1)-320(N) calls report comparison queries 330 to retrieve the requested data from the history datastore 290 or from a combination of datastores. The report layout programs 320(1)-320(N) is called from consolidated report template 305 with a multitude of unique project identifier 260, the name of the specific report layout program, and the name of the query to use from report comparison queries 330. The flexible structure allows each report layout program 320(1)-320(N) to be configured to compare or benchmark a multitude of projects. Report layout programs 320(1)-320(N) returns the results to consolidated report 340; the results are rendered in a user interface 729 to the end-user over the network 705.

The history datastore 290 is populated with historical project records, where each project is one row and contains all the data for report layout programs 320(1)-320(N) that are included in consolidated report 340 and queried by report comparison queries 330. Alternatively, the history datastore 290 may contain one reference record that statistically represents historical project records. A reference record is precalculated summaries that represent statistical measurements for a classification group. History datastore 290 should contain either real project histories or representative records; the types of entries should not be mixed. Report comparison queries 330 should be constructed to account for the difference in querying for a reference record or cumulating history data. Including a data item indicator to select reference records in comparison, queries have proven an effective approach to distinguish the query types. Data from the history datastore 290 can be combined with data from other datastores. The report illustrated in FIG. 5. Relies on a history datastore 290 that contains historical project data items for project scope data (as described in the Project Scope Model), project performance data (e.g., budget, time, requirements, overall performance), team structure data (as described in TS Model), stakeholder involvement data (e.g., business user, top management, senior management importance), stakeholder participation data (e.g. business user, top management senior management project tasks), organizational performance data (e.g., business, operational, strategic expectations from the project), system quality data (e.g., system performance features), information quality data (e.g., data performance features), and service quality data (e.g., human people performance).

The database queries in report comparison queries 330 are designed to select the data for the project under investigation, which is identified by unique project identifier 260, and to select other data entries that have the same project classification as the project under investigation. The data entries are selected from a database located on a database server 730. Database union statements have proven an effective combination for selecting this data for a report. The database queries are based upon selecting all transactions for a multitude of project class 240. The project classification is determined by the scope defined in the report layout programs 320(1)-320(N). The data items or project attributes that should be selected are also determined by the specific requirements for report layout programs 320(1)-320(N). In FIG. 5, the queries are computing average values or differences or displaying absolute values of project attributes from the history datastore 290. The queries are not limited to the history datastore 290, and other datastores may be combined, or different computations may be used.

Report layout programs 320(1)-320(N) are each individual computer program based on a programming language such as JavaScript. Each program contains software code that determines the report layout. While d3js, a JavaScript library, was used to create the reports, other programs such as visual basic with spreadsheets may be used. Examples of report styles include: line chart, bullet chart, Venn diagram, waterfall chart, sortable table, parallel coordinates, multiline graph, positive-negative bar chart, Voronoi rank chart, radar chart, path diagram, divergent stacked bar chart, radial, multiple radials, multi-column bar chart, multiple circles, multiple pies, and world map; other graph types are possible.

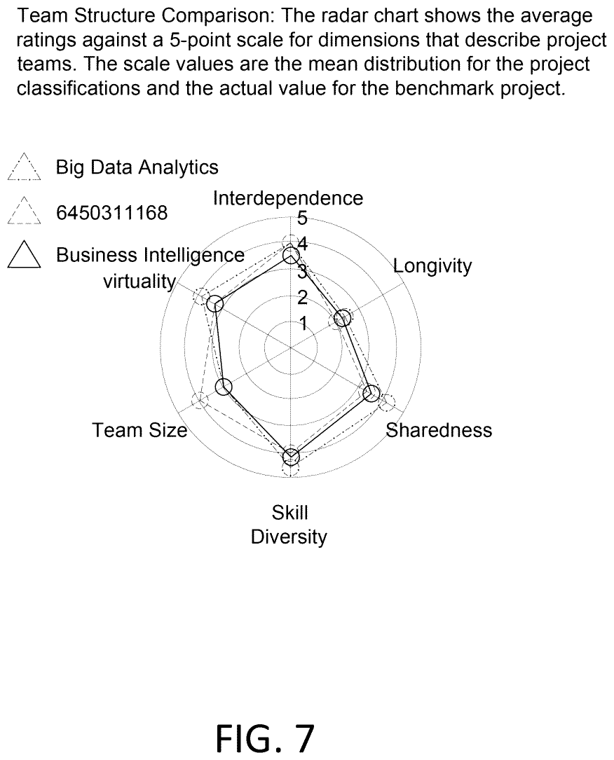

FIG. 5 demonstrates the visualization of consolidated report 340, and FIG. 7 demonstrates a radar diagram that compares a project with the unique identifier to two classes-big data and business intelligence-for team structure composition project attributes.

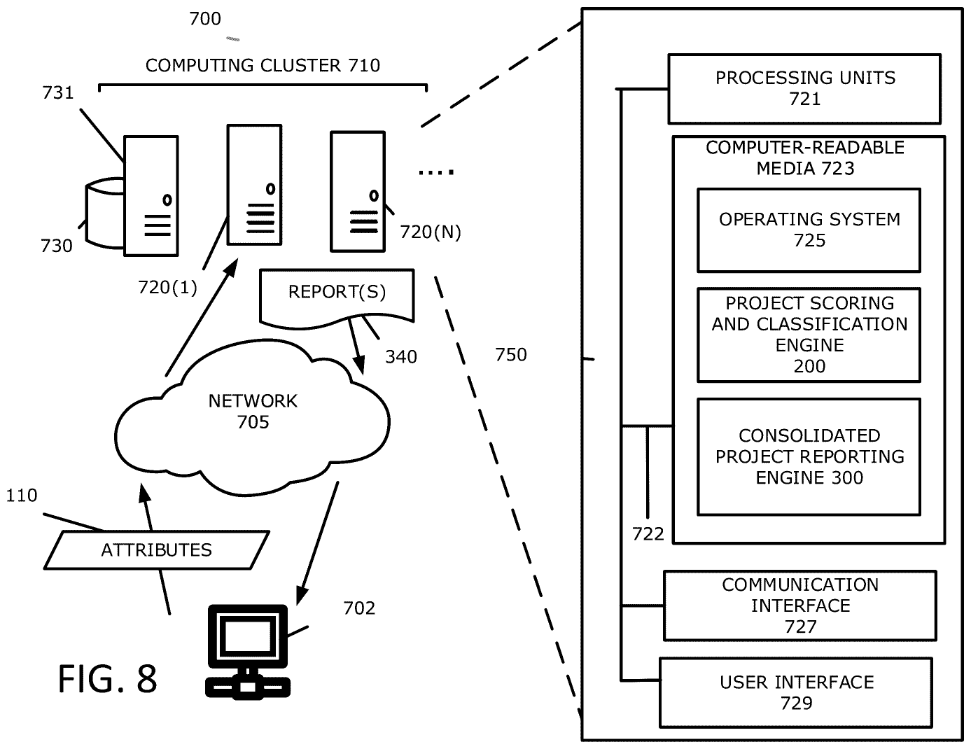

FIG. 8 illustrates an example computing environment 700 in which the system described herein can be hosted, operated, and used. In the figure, the computing device 702, computer servers 720(1)-720(N), and database server 730 can be used individually or collectively, where N is an integer greater than or equal to one. Database server 730 is comprised of computer servers 720(1)-720(N) and database software for storing, manipulating, and retrieving structured or non-structured data. Although computing device 702 is illustrated as a desktop computer, computing device 702 can include diverse device categories, classes, or types such as laptop computers, mobile telephones, tablet computers, and desktop computers and is not limited to a specific type of device. Computer servers 720(1)-720(N) can be computing nodes in a computing cluster 710, for example, cloud services such as Dreamhost, Microsoft azure, or amazon web services. Cloud computing is a service model where computing resources are shared among multiple parties and is made available over a network on demand. Cloud computing environments provide computing power, software, information, databases, and network connectivity over the Internet. The internet is a computer data network that is an open platform that can be used, viewed, and influenced by individuals and organizations. Within this disclosure, the computing environment refers to the computing or database environment made available as a cloud service. Resources including processor cycles, disk space, random-access memory, network bandwidth, backup, resource, tape space, disk mounting, electrical power, etc., are considered included in the cloud services. In the diagram, the computing device 702 can be clients of computing cluster 710 and can submit programs or jobs to computing cluster 710 and/or receive job results or data from computing cluster 710. Computing device 702 is not limited to being a client of computing cluster 710 and maybe a part of any other computing cluster.

Computing device 702, computer servers 720(1)-720(N), or database servers 730 can communicate through other computing devices via one or more network 705. Inset 750 illustrates the details of computer servers 720(N). The details for the computer servers 720(N) are also a representative example for other computing devices such as computing device 702 and computer servers 720(1) -720(N). Computing device 702 and computer servers 720(1)-720(N) can include alternative hardware and software components. Referring to FIG. 8 and using computer servers 720(N) as an example, computer servers 720(N) can include computer memory 724 and one or more processing units 721 connected to one or more computer-readable media 723 via one or more of buses 722. The buses 722 may be a combination of a system bus, a data bus, an address bus, local, peripheral, or independent buses, or any combination of buses. Multiple processing units 721 may exchange data via an internal interface bus or via a network 705.

Herein, computer-readable media 723 refers to and includes computer storage media. Computer storage media is used for the storage of data and information and includes volatile and nonvolatile memory, persistent and auxiliary computer storage media, removable and non-removable computer storage technology. Communication media can be embodied in computer-readable infrastructure, data structure, program modules, data signals, and the transmission mechanism.

Computer-readable media 723 can store instructions executable by the processing units 721 embedded in computing device 702, and computer-readable media 723 can store instructions for execution by an external processing unit. For example, computer-readable media 723 can store, load, and execute code for an operating system 725, programs for project scoring and classification engine 200 and the consolidated project reporting engine 300, and for other programs and applications. One or more processing units 721 can be connected to computer-readable media 723 in computing device 702 or computer servers 720(1)-720(N) via a communication interface 727 and network 705. For example, program code to perform steps of the flow diagram in FIG. 8 can be downloaded from the computer servers 720(1)-720(N) to computer device 702 via the network and executed by one or more processing units 721 in the computing device 702.

Computer-readable media 723 of the computing can store an operating system 725 that may include components to enable or direct the computing device 702 to receive data via inputs and process the data using the processing units 721 to generate output. The operating system 725 can further include components that present output, store data in memory, transmit data. The operating system 725 can enable end-users of user interface 729 to interact with computer servers 720(1)-720(N). The operating system 725 can include other general-purpose components to perform functions such as storage management and internal device management.

Computer servers 720(1)-720(N) can include a user interface 729 to permit the end-user to operate the project attribute data entry 105 and project unique identifier data entry 301 and interact with consolidated report 340. An example of user interaction through the processing units 721 of computing device 702 receives input of user actions via user interface 729 and transmits the corresponding data via communication interfaces 727 to computer servers 720.

User interface 729 can include one or more input devices and one or more output devices. The output devices can be configured for communication to the user or other computing device 702 or computer servers 720(1)-720(N). A display, a printer, audio speaker are example output devices. The input devices can be user-operated or receive input from other computing devices 702 or computer servers 720(1)-720(N). Keyboard, keypad, mouse, and trackpad are examples of input devices. Dataset 731 is electronic content having any type of structure, including structured and unstructured data, free-form text, or tabular data. Structured dataset 731 include, for example, one or more data items, also known as columns or fields, and one or more rows, also known as observations. Dataset 731 include, for example, free-form text, images, or videos as unstructured data. consolidated report 340 is physical or electronic documents with content produced as the results of executing programs for the consolidated project reporting engine 300, and other programs and applications. Project attributes 110 can include discrete values or continuous values.

### OPERATIONS

Before the first use in operations, the system must be configured based on specific models or for the models described in his disclosure. Off-the-shelf software tools for manipulating hypertext markup language code, updating databases, or creating software programs should be utilized for the configuration actions. The detailed considerations and specifications for use are described in the detailed disclosure. The following are summary steps to consider in the first usage.

The project models 205 described in this disclosure are already encoded for use in compute project score 230; the models and programs can be adjusted to use alternative models. This includes programming the model specification 206 into the compute project score 230.

The history datastore 290 should be populated with historical project data or with reference data. In this context, populating means adding database entries into the history datastore 290. The disclosures structure imposes no limitations on the data that may be included. The minimal database structure should consider data items for unique project identifier 260, per-each of the project models 205, a project score 220, a project class identifier 221, and a project class label 222; a project attributes 110, and an indicator if historical or reference data are used.

One or more report programs may be added, deleted, or changed in the consolidated report template 305 to reach the desired structure of comparison reporting. The report comparison queries must contain the instructions for the data to populate the report layout programs. The following are some of the use cases for the solution: identify historical projects for performance management, planning, and estimating new projects; provide a baseline for comparing performance between similar projects: or reporting the status of the current state of the project versus an earlier anticipated state or similar projects.

The project scoring and classification engine 200 and the consolidated project reporting engine 300 must be deployed to computing cluster 710.

### SUMMARY

The figures are block diagrams that illustrate a logical flow of the defined process. The blocks represent one or more operations that can be implemented in hardware, software, or a combination of hardware and software. The software operations are computer-executable instructions stored in computer-readable media that, when executed by one or processors performed the defined operations. The computer-executable instructions include programs, objects, functions, data structures, and components that perform actions based upon instructions. The order of presentation of the figures and process flows is not intended to limit or define the order in which the operations can occur. The processes can be executed in any order or in parallel. The processes described herein can be performed by resources associated with computing device 702 or computer servers 720(1)-720(N). The methods and processes described in this disclosure can be fully automated with software code programs executed by one or more general-purpose computers or processes. The code programs can be stored in any type of computer-readable storage medium or other computer storage device.

While this disclosure contains many specific details in the process flows, these are not presented as limitations on the scope or of what may be claimed. These details are a description of features that may be specific to a particular process of particular inventions. Certain features that are described in this process flow in the context of separate figures may also be implemented as a single or a combined process. Features described as a single process flow may also be implemented in multiple processes flows separately or in any suitable combination. Furthermore, although features may be described as combinations in the specification or claims, one or more features may be added to or removed from the combination and directed to an alternative combination or variation of a combination.

The methods and processes described can be embodied in and automated via software code executed by one or more general-purpose computers or processors. The software code can be stored in a computer-readable storage device.

What is claimed:

1. A computer-implemented method for generating a consolidated report of project comparison and benchmarking insights to enhance project planning and forecasting, the method executed by one or more processors in communication with computer-readable media, a database server, a communication interface, and a user interface, the method comprising:
receiving, via an end-user input or automated data retrieval, a unique project identifier through a computing device over a network or from computer memory, wherein the unique project identifier corresponds to a specific project record in a history datastore stored on the database server;
accessing, by one or more processors, a consolidated report template stored in the computer-readable media for generating the consolidated report, the consolidated report template configured to call one or more report layout programs, wherein each report layout program is stored in the computer-readable media and comprises a graphic report design for structuring data into visual and tabular formats and a report comparison query for retrieving benchmarking insights;
executing, by one or more processors, each report comparison query to retrieve benchmarking data by accessing the database server, wherein the benchmarking data includes:
the specific project record selected from the history datastore corresponding to the unique project identifier, and
benchmarking data matching a project class identifier associated with the unique project identifier in the specific project record;
processing, by one or more processors, the retrieved benchmarking data and the specific project record within each report layout program to:
generate visual and tabular comparisons using each graphic report design, and
create benchmarking insights by aggregating the retrieved benchmarking data from similar projects associated with the project class identifier;
combining, by one or more processors, the benchmarking insights into the consolidated report using the consolidated report template, wherein the consolidated report includes graphical representations comparing the specific project record with similar projects to support project planning and forecasting; and
rendering, by one or more processors, the consolidated report to the end-user via the user interface over the network, providing structured output of the specific project record and benchmarking insights, thereby improving project planning and forecasting systems by removing limitations on subjects and visualizations available for decision-making.

2. The method of claim 1, further comprising:
a consolidated report template is configured to call 10 report layout programs where each report layout program is configured to process historical data form the history datastore and each graphic report design is configured to generate visualizations for benchmarking insights to support project planning and forecasting.

3. The method of claim 2, wherein:
for report layout program one, the graphic report design produces a line chart and the report comparison query one selects average values for project scope data;
for report layout program two, the graphic report design produces multiple circles and the report comparison query two selects average values for project performance data;
for report layout program three, the graphic report design produces a radar chart and the report comparison query three selects average values for team structure data;
for report layout program four, the graphic report design produces a radar chart and the report comparison query four selects average values for project scope attributes data;
for report layout program five, the graphic report design produces a multi-column bar chart and the report comparison query five selects average values for stakeholder involvement data;
for report layout program six, the graphic report design produces a multi-column bar chart and the report comparison query six selects average values for stakeholder participation data;
for report layout program seven, the graphic report design produces a positive-negative bar chart and the report comparison query seven selects average values for organizational performance data;
for report layout program eight, the graphic report design produces a positive-negative bar chart and the report comparison query eight selects average values for system quality data;
for report layout program nine, the graphic report design produces a positive-negative bar chart, and the report comparison query nine selects average values for information quality data;
for report layout program 10, the graphic report design produces a positive-negative bar chart, and the report comparison query 10 selects average values for service quality data;
integrating retrieved benchmarking data into a consolidated report, wherein the consolidated report combines output of the report layout programs one to 10 into a single report layout; and
delivering the consolidated report via a user interface over a network to an end-user, wherein the consolidated report enables project estimation and forecasting by presenting performance data, benchmarking insights, and visual analyses for project scope, performance, and quality attributes.

4. The method in claim 1, wherein the history datastore is populated with reference data.

5. The method in claim 1, wherein the history datastore is populated with historical project data.

6. The method in claim 1 further, wherein a graphic report design produces visualization in a scalable vector graphic format.

7. The method in claim 1 further comprising a multitude of unique project identifiers are provided for comparing two or more specific project records.

8. A computer-implemented method executed on a computing device comprising one or more processing units in communication with computer-readable media, a network, and a database server, for improving project planning and forecasting software through automated forecasting of project and organizational performance and generating a consolidated report, the method comprising:
receiving, via an end-user input or automated data retrieval, a unique project identifier through a computing device over a network or from computer memory, wherein the unique project identifier corresponds to a specific project record in a history datastore stored on the database server;
accessing a consolidated report template stored in the computer-readable media for generating the consolidated report by calling one or more report layout programs, wherein each report layout program is stored in the computer-readable media and includes a graphic report design for structuring data into visual and tabular formats and a project model configured to compute a project score, a project class identifier, and a project class;
wherein the project models are defined by a model specification comprising dimensions, classes, scoring rules, and classification rules to ensure context-relevant classification of project data and enable processing by a multitude of computational models;
executing, by one or more processors, each report comparison query to access the database server to select the specific project record from the history datastore corresponding to the unique project identifier;
executing, by one or more processors, each project model based on the model specification to consolidate data types and project subjects by transforming structured and unstructured data, free-form text, and tabular data into model dimension values comprising the project score, project class identifier, and project class based on the specific project record;
processing the model dimension values and the specific project record in each report layout program to generate visual and tabular comparisons using each graphic report design and to create dynamic insights, thereby overcoming limitations of selecting comparable projects using heterogeneous data formats;
combining the dynamic insights into the consolidated report using the consolidated report template, wherein the consolidated report includes graphical representations comparing the specific project record with the model dimension values to support in project planning and forecasting; and
rendering the consolidated report to the end-user via the user interface over the network, providing structured output of the specific project record and dynamic insights that improve project planning and forecasting systems by removing limitations on the data types and computational models used for selecting comparable projects, and subjects and visualizations available for decision-making.

9. The method in claim 8, wherein the project models include a project scope model and a team structure model;
wherein the project scope model has two model classes with a model class identifiers of one and two and model class labels of “Big Data Analytics” and “Business Intelligence,” and it has four model dimensions with model dimension identifiers of PS_1, PS_2, PS_3, PS_4 for generating insights on by attributes of the project;
wherein the team structure model has two model classes with the model class identifiers of one and two and model class labels of “Implementation” and “Maintenance,” and it has six model dimensions with model dimension identifiers of F_TS_1, F_TS_2, F_TS_3, PA_CalDur, PA_CalSkill, and PA_CalTeam for generating insights on by attributes of a team composition; and
rendering the consolidated report to an end-user via the user interface over the network, providing structured output on the project scope and team composition as dynamic insights to support project planning and forecasting.

10. A computer-implemented method executed on a computing device comprising one or more processing units in communication with computer-readable media, a network, and a database server, for improving project planning and forecasting software through automated forecasting of project and organizational performance and generating a consolidated report, the method comprising:
receiving, via an end-user input or automated data retrieval, a unique project identifier through a computing device over a network or from computer memory, wherein the unique project identifier corresponds to a specific project record stored in a history datastore on the database server;
accessing, by one or more processors, a consolidated report template stored in the computer-readable media for generating the consolidated report, the template configured to call one or more report layout programs, wherein each report layout program is stored in the computer-readable media and comprises: a graphic report design for structuring data into visual and tabular formats, and a report comparison query for retrieving benchmarking insights or a project model for computing a project score, a project class identifier, and a project class;
wherein the project models are defined through a model specification comprising dimensions, classes, scoring rules, and classification rules to ensure context-relevant classification of project data and enable processing by a multitude of computational models;
executing, by one or more processors, each report comparison query to access the database server, selecting the specific project record from the history datastore corresponding to the unique project identifier, and identifying and retrieving benchmarking data matching a project class identifier associated with the unique project identifier;
executing, by one or more processors, each project model based on the model specification to consolidate data types and project subjects by transforming structured and unstructured data, free-form text, and tabular data into model dimension values comprising the project score, project class identifier, and project class based on the specific project record;
processing, by one or more processors, the retrieved benchmarking data, the model dimension values, and the specific project record within each report layout program to: generate visual and tabular comparisons using each graphic report design, aggregate the benchmarking data from similar projects within the project class identifier, and create dynamic insights that overcome limitations of selecting comparable projects using heterogeneous data formats;
combining, by one or more processors, the benchmarking insights and dynamic insights into the consolidated report using the consolidated report template, wherein the consolidated report includes graphical representations comparing: the specific project record with the model dimension values, and similar projects to support project planning and forecasting; and
rendering, by one or more processors, the consolidated report to the end-user via the user interface over the network, providing structured output of the specific project record and dynamic insights to improve project planning and forecasting systems by removing limitations on: data types and computational models used for selecting comparable projects, and subjects and visualizations available for decision-making.
